(19) United States
(12) Patent Application Publication
(10) Pub. No.: US 2025/0362502 A1
(43) Pub. Date: Nov. 27, 2025

(54) APPARATUS, SYSTEM, AND METHOD FOR APPROXIMATING NEURAL COMPUTE FOR GRAPHICS GENERATION VIA HARDWARE ACCELERATORS

(71) Applicant: Meta Platforms Technologies, LLC, Menlo Park, CA (US)

(72) Inventors: Sushant Kondguli, Newark, CA (US); Carl Marshall, Portland, OR (US); Shyam Murthy, Madison, WI (US)

(21) Appl. No.: 19/215,892

(22) Filed: May 22, 2025

Related U.S. Application Data
(60) Provisional application No. 63/651,657, filed on May 24, 2024.

(51) Int. Cl. G02B 27/01; G06T 1/20; G06T 15/80

(52) U.S. Cl. CPC G02B 27/017; G06T 1/20; G06T 15/80; G02B 2027/0178

(57) ABSTRACT

An eyewear device comprising (1) an eyewear frame dimensioned to be worn by a user, (2) circuitry coupled to the eyewear frame, the circuitry comprising a hardware accelerator configured to (A) identify an input that indicates one or more features of an instance of graphical imagery and (B) perform, based at least in part on the input, one or more lookup operations via one or more arrays to obtain an output used to approximate computation of a rendering of the instance of graphical imagery, and (3) a display coupled to the eyewear frame and configured to present the rendering of the instance of graphical imagery to the user. Various other apparatuses, systems, and methods are also disclosed.

### PRIORITY CLAIM

This application claims the benefit of U.S. Provisional Application No. 63/651,657 filed May 24, 2024, the disclosure of which is incorporated in its entirety by this reference.

### BRIEF DESCRIPTION OF DRAWINGS

The accompanying drawings illustrate a number of example embodiments and are a part of the specification. Together with the following description, these drawings demonstrate and explain various principles of the instant disclosure.

FIG. 1 is an illustration of an exemplary eyewear for approximating neural compute for graphics generation via hardware accelerators according to one or more implementations of this disclosure.

FIG. 2 is an illustration of an exemplary eyewear device for approximating neural compute for graphics generation via hardware accelerators according to one or more implementations of this disclosure.

FIG. 3 is an illustration of exemplary lookup operations performed by a system that approximates neural compute for graphics generation via hardware accelerators according to one or more implementations of this disclosure.

FIG. 4 is an illustration of an exemplary implementation of a hardware accelerator for approximating neural compute for graphics generation according to one or more implementations of this disclosure.

FIG. 5 is an illustration of exemplary circuitry for approximating neural compute for graphics generation via hardware accelerators according to one or more implementations of this disclosure.

FIG. 6 is a flow diagram of an exemplary method for approximating neural compute for graphics generation via hardware accelerators according to one or more implementations of this disclosure.

FIG. 7 is an illustration of exemplary augmented-reality glasses that may be used in connection with one or more implementations of this disclosure.

FIG. 8 is an illustration of an exemplary virtual-reality headset that may be used in connection with one or more implementations of this disclosure.

While the exemplary embodiments described herein are susceptible to various modifications and alternative forms, specific embodiments have been shown by way of example in the appendices and will be described in detail herein. However, the exemplary embodiments described herein are not intended to be limited to the particular forms disclosed. Rather, the instant disclosure covers all modifications, combinations, equivalents, and alternatives falling within this disclosure.

### DETAILED DESCRIPTION OF EXEMPLARY EMBODIMENTS

The present disclosure is generally directed to apparatuses, systems, and methods for approximating neural compute for graphics generation via hardware accelerators. As will be explained in greater detail below, these apparatuses, systems, and methods may provide numerous features and benefits.

In some examples, eyewear devices like head-mounted displays (HMDs) have revolutionized the way people experience various kinds of digital media. For example, HMDs may allow users of artificial reality to experience realistic, immersive virtual and/or augmented environments. Artificial reality may provide users with opportunities to interact with virtual objects and/or environments in one way or another. In this context, artificial reality may constitute a form of reality that has been altered by virtual objects for presentation to a user. Such artificial reality may include and/or represent virtual reality (VR), augmented reality (AR), mixed reality, hybrid reality, or some combination and/or variation of one or more of the same.

Although artificial-reality systems are commonly implemented for gaming and other entertainment purposes, such systems are also implemented for purposes outside of recreation. For example, governments may use them for military training simulations, pilots may use them for flight simulations, doctors may use them to practice surgery, engineers may use them as visualization aids, and co-workers may use them to facilitate inter-personal interactions and collaboration from across the globe.

Some HMDs may incorporate and/or implement graphics processing units (GPUs) and/or graphics pipelines for computing, processing, generating, and/or rendering graphics for presentation on a display. In some examples, the GPUs and/or graphics pipelines may execute, perform, and/or implement shading (e.g., fragment and/or pixel shading), compression, and/or other graphics-related algorithms in connection with such graphics computation and/or generation. Unfortunately, certain implementations of such algorithms may be power-intensive and/or compute-intensive, and certain HMDs may have limited power and/or compute available to support such algorithms due to their battery and/or graphics-hardware constraints. As a result, those HMDs may be unable to pragmatically execute, perform, and/or implement such algorithms in connection with graphics computation and/or generation.

As a specific example, an advanced rendering algorithm, such as a bidirectional reflectance distribution function (BRDF) algorithm, may be able to significantly enhance the rendering quality of graphics. However, some AR/VR HMDs may be unable to facilitate and/or support the power demands and/or requirements of GPUs and/or graphics pipelines that execute, perform, and/or implement such advanced rendering algorithms. In other words, such advanced rendering algorithms may fall outside the power budget and/or capabilities of those AR/VR HMDs. Additionally or alternatively, such advanced rendering algorithms may take too much time to process and/or render graphics with enhanced quality. As a result, some AR/VR HMDs may degrade and/or reduce the quality of images rendered for display, thereby effectively impairing users' experiences in the AR/VR environment.

In some examples, the apparatuses, systems, and methods described herein may implement and/or achieve increased and/or improved quality of the images rendered for display on AR/VR HMDs without the same power and/or time demands. For example, an AR/VR HMD may include and/or represent circuitry that maps power-intensive, compute-intensive, and/or time-intensive advanced rendering algorithms, such as BRDF algorithms, to neural encoder/decoder architectures. In this example, the AR/VR HMD may effectively trade, swap, and/or replace certain compute operations involved in such advanced rendering algorithms with a few memory lookup operations. Additionally or alternatively, the AR/VR HMD may include, represent, and/or implement a hardware accelerator for the neural encoder/decoder architectures. In certain implementations, the hardware accelerator may perform and/or execute the memory lookup operations corresponding to the traded, swapped, and/or replaced compute operations.

In some examples, the hardware accelerator may decrease and/or reduce the power demands and/or requirements of such advanced rendering algorithms by up to 3 times or more. As a result of this decrease and/or reduction afforded by the hardware accelerator, the power demands and/or requirements of such advanced rendering algorithms may no longer be outside the power budget and/or time budget of the AR/VR HMD. As a result, the AR/VR HMD may increase and/or enhance the quality of images rendered for display, thereby effectively improving the user's experience in the AR/VR environment.

In some examples, the hardware accelerator may involve and/or implement a neural network, such as a multilayer perceptron (MLP), for the purpose of performing and/or executing certain operations (e.g., memory lookups) in connection with computation and/or generation of a neural graphics primitive. In one example, this neural graphics primitive may effectively replace the computation with a pointer indirection. In this example, the pointer indirection may constitute and/or amount to a query of a memory location that points to another memory location where a final output value is stored and/or maintained. In certain implementations, the neural network may learn the pointer indirection values applied in this technique using gradient decent.

In some examples, the neural network may involve and/or implement a primary array that stores the pointer indirection values and/or a cascaded array (e.g., a 16-by-16 array) whose output corresponds to and/or represents the computation and/or generation of the neural graphics primitive. In one example, the neural network may perform and/or execute two consecutive lookups of the primary array and/or the cascaded array, which cause and/or result in the cascaded array outputting the computation and/or generation of the neural graphics primitive. In certain implementations, this sequence and/or combination of lookups and outputs may be referred to as an indirection pair.

In some examples, the neural network may be scaled to handle an increased number of inputs and/or multidimensional inputs. In one example, the neural network may facilitate, support, and/or implement a differential indirection primitive with and/or through an architecture consisting of multiple primary and/or cascaded arrays. In this example, the multiple primary and/or cascaded arrays may enable the neural network to achieve multiple indirection pairs. In certain implementations, the final output of such arrays may include and/or represent a function of a viewing direction and/or orientation. Additionally or alternatively, the output(s) obtained from the indirection pairs may be combined to produce the final output of the function.

In some examples, BRDF algorithms may include and/or represent mathematical functions that simulate the scattering of light as it travels through different media. For example, one BRDF algorithm may include and/or represent a variation that facilitates and/or supports modeling a variety of materials. In one example, the AR/VR HMD and/or the neural network may decompose and/or reduce the BRDF algorithms into certain indirection pairs whose outputs are subsequently combined to produce final approximations of the BRDF algorithms. In certain implementations, the decomposition and/or reduction of the BRDF algorithms may constitute and/or represent differential indirection primitives. Such differential indirection primitives may facilitate and/or support compute approximations that leverage and/or rely on compressed lookup tables stored and/or maintained in memory.

In some examples, the differential indirection primitives may enable the neural network and/or the AR/VR HMD to approximate the compute for certain tasks, to compress input textures for certain programs, and/or to compress and/or represent various two-dimensional (2D) and/or three-dimensional (3D) graphics. In one example, the implementation of such differential indirection primitives may reduce the amount of energy consumed and/or used by the AR/VR HMD and/or its graphics pipeline.

In some examples, the AR/VR HMD may achieve one or more differential indirection primitives by implementing indirection pairs (e.g., back-to-back memory lookups of the primary array followed by the cascaded array) and/or pointer loads. In one example, the AR/VR HMD may include and/or represent control logic and/or other circuitry that facilitates and/or supports using the selection of texture outputs as inputs to a subsequent texture operation. In one example, the AR/VR HMD may include and/or represent arithmetic logic units (ALUs), multipliers, floating-point units (FPUs), and/or other circuitry positioned and/or implemented proximate to the texture memory hierarchy to combine the outputs of one or more cascaded arrays to produce a final approximation of a BRDF algorithm and/or a function of the viewing direction.

In some examples, hardware accelerators may provide image analysis, image processing, trainable models (e.g., a neural network), object tracking (e.g., hand or eye tracking), object identification, and/or other processes. In one example, hardware accelerators may each be implemented as some or all of a GPU, a system on a chip (SoC), and/or as an application-specific integrated circuit (ASIC).

In some examples, hardware accelerators may each include and/or represent a hardware component or device that performs one or more specialized computing tasks more efficiently, in hardware, than the computing task would be performed in software by a general-purpose central processing unit (i.e., a computing chip that is structured to execute a range of different programs as software). In such examples, the hardware accelerators may each support and/or contribute to an artificial neural network (ANN). In some embodiments, the term “hardware acceleration” may refer to the execution of a computing task in application-specific hardware circuitry (e.g., a GPU or an ASIC) that occurs in the absence of a software module intermediary or other layer of abstraction such that the performance of the computing task is more efficient than when executed otherwise. Examples of ANNs include, without limitation, convolutional neural networks, deep neural networks, multilayer perceptrons, recursive neural networks, recurrent neural networks, variations or combinations of one or more of the same, and/or any other suitable ANNs.

In some examples, the hardware accelerators may include one or more local memory devices, such as a type volatile or non-volatile storage device or medium capable of storing data and/or computer-readable instructions. In one example, the local memory devices may store, load, receive, and/or maintain data local to (e.g., communicatively coupled via a high-speed, low-power, and/or low-latency bus), accessed by, and/or utilized by one or more compute engines included in one or more of the hardware accelerators.

In some examples, the AR/VR HMD may include and/or represent circuitry that facilities and/or support approximating neural compute for graphics generation via hardware accelerators. In one example, the circuitry may also perform one or more actions in response to user input. Examples of such actions include, without limitation, generating virtual content presented via optical elements (e.g., lenses), selecting virtual buttons from an array, modifying virtual content presented via optical elements, initiating a telephone call, sending a text message or other communication, executing a computing command and/or instruction, combinations of one or more of the same, and/or any other suitable actions.

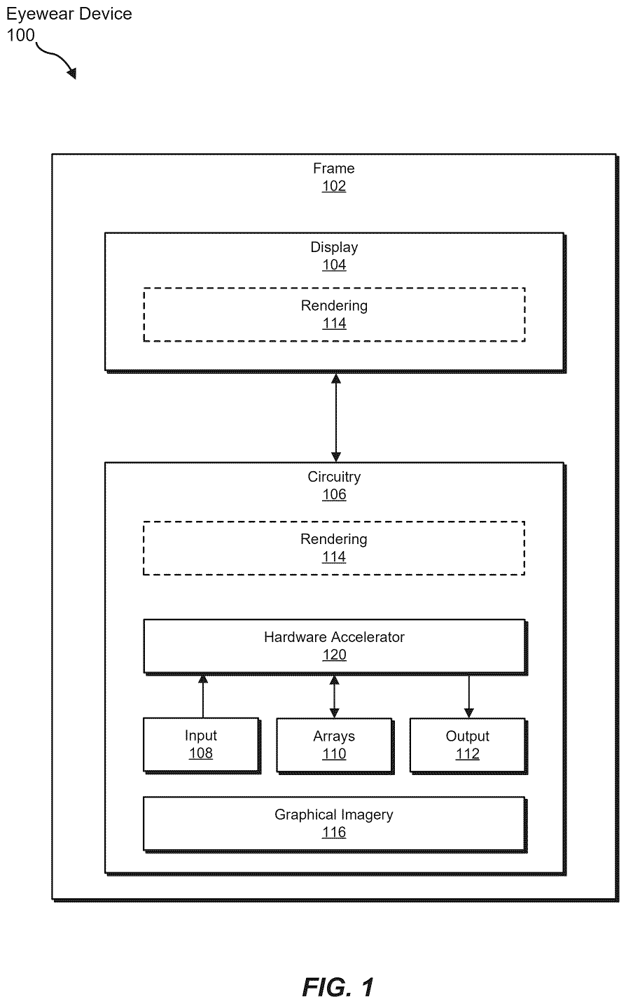

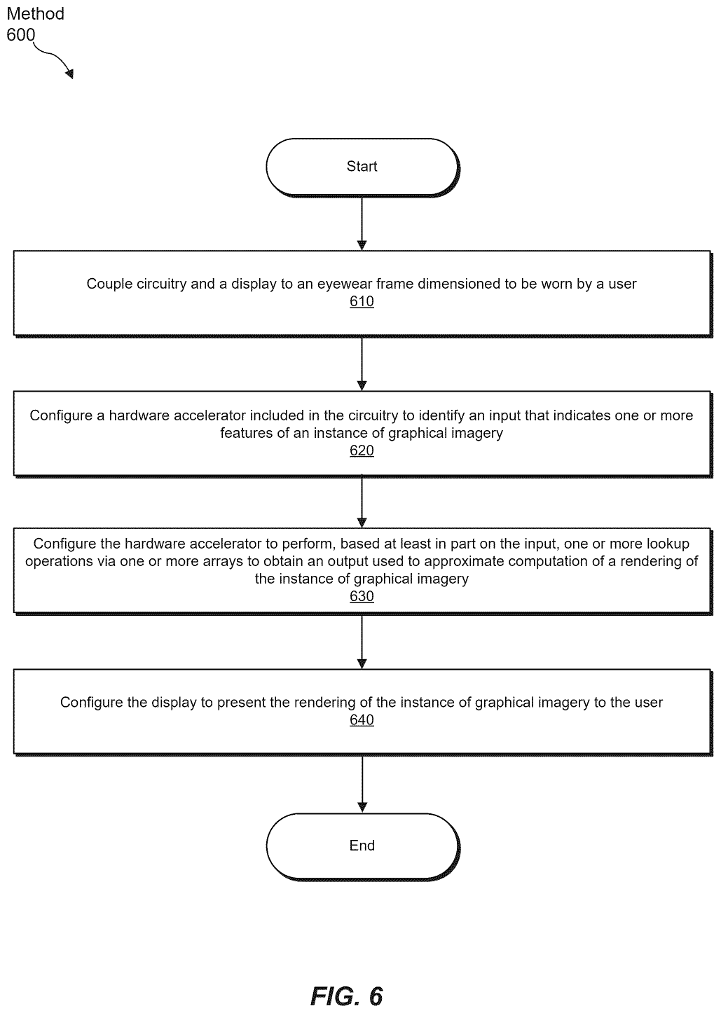

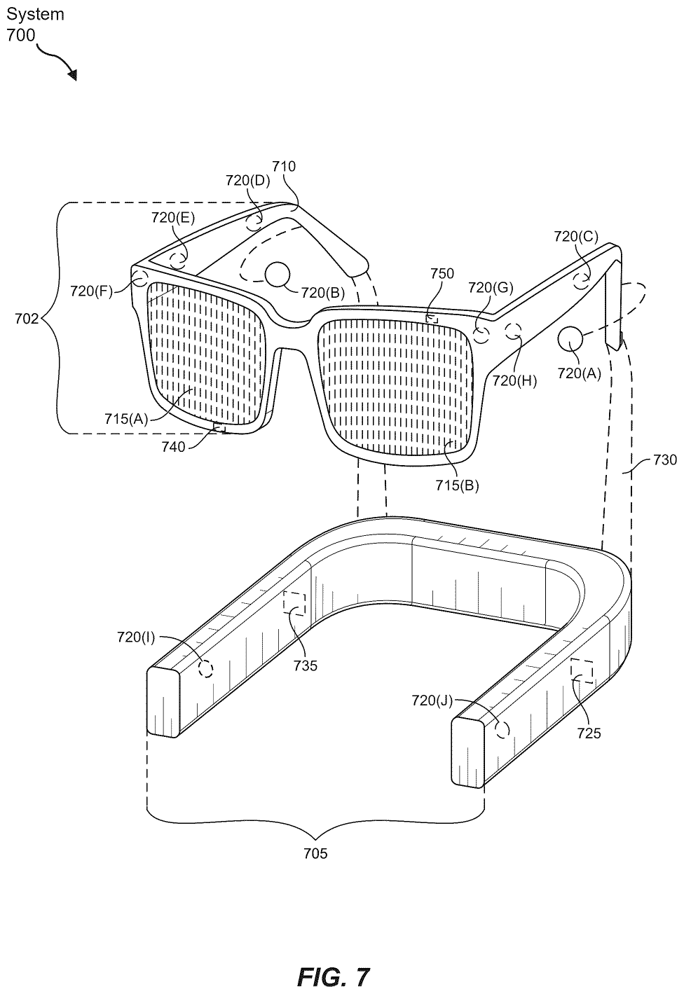

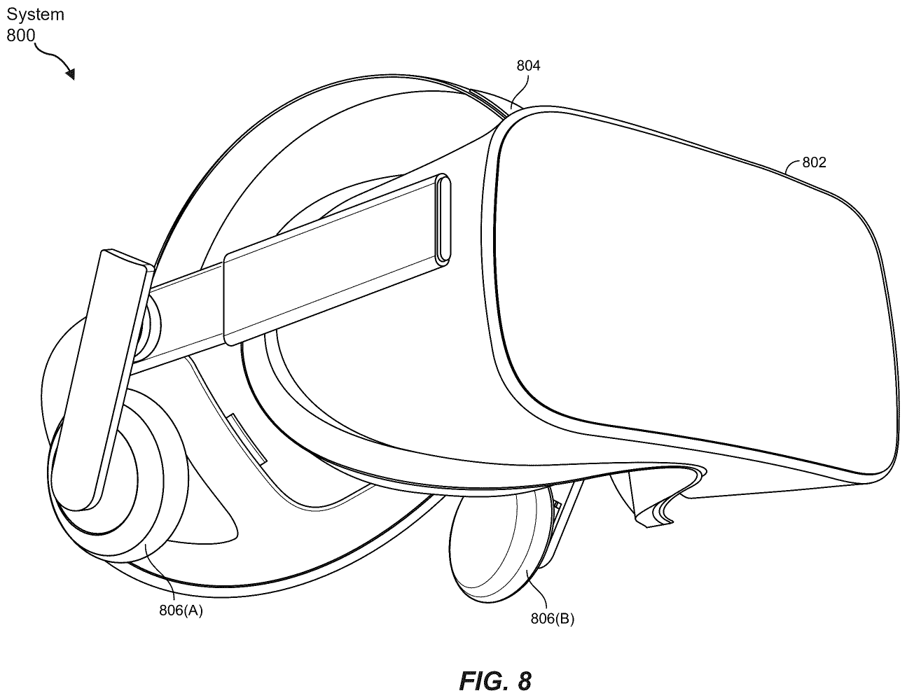

The following will provide, with reference to FIGS. 1-5, detailed descriptions of exemplary apparatuses, devices, systems, components, and corresponding configurations or implementations for approximating neural compute for graphics generation via hardware accelerators. In addition, detailed descriptions of methods for approximating neural compute for graphics generation via hardware accelerators will be provided in connection with FIG. 6. The discussion corresponding to FIGS. 7 and 8 will provide detailed descriptions of types of exemplary artificial-reality devices, wearables, and/or associated systems capable of approximating neural compute for graphics generation via hardware accelerators.

FIG. 1 illustrates an exemplary eyewear device 100 for approximating neural compute for graphics generation via hardware accelerators. As illustrated in FIG. 1, eyewear device 100 may include and/or represent a frame 102 dimensioned to be worn by a user. In some examples, frame 102 may include and/or be equipped with a display 104 and/or circuitry 106. In one example, display 104 and/or circuitry 106 may be coupled and/or secured to frame 102.

In some examples, circuitry 106 may include and/or represent a hardware accelerator 120 that detects, identifies, and/or generates an input 108 indicative and/or representative of one or more features of an instance of graphical imagery 116. In one example, hardware accelerator 120 may also execute and/or perform one or more lookup operations via arrays 110 (e.g., a primary array and/or a cascaded array) based at least in part on input 108. By doing so, hardware accelerator 120 may locate and/or obtain an output 112 used to approximate computation of a rendering 114 of the instance of graphical imagery 116. In certain implementations, display 104 may present and/or display rendering 114 of the instance of graphical imagery 116 for the user.

In some examples, input 108 may indicate, characterize, and/or describe the features of graphical imagery 116. For example, input 108 may constitute and/or represent a description of a scene depicted in graphical imagery 116. Additional examples of such features include, without limitation, directions of light applied to or represented in graphical imagery 116, types of light sources involved in graphical imagery 116, identification of materials depicted in graphical imagery 116, geometry involved in graphical imagery 116, types of cameras involved in graphical imagery 116, the surface roughness of at least a portion of graphical imagery 116, the metallicity of at least a portion of graphical imagery 116, the anisotropy of at least a portion of graphical imagery 116, the specularity of at least a portion of graphical imagery 116, the sheen of at least a portion of graphical imagery 116, the orientation of eyewear device 100, combinations or variations of one or more of the same, and/or any other suitable features of graphical imagery.

In some examples, hardware accelerator 120 may execute, perform, and/or implement shading, texturing, compression, graphics rendering, and/or blending on graphical imagery 116 via output 112. For example, hardware accelerator 120 may apply and/or use output 112 to approximate the neural compute involved in generating, processing, and/or rendering graphical imagery 116. In one example, output 112 may include and/or represent a function that approximates, simulates, and/or replaces a graphics-rendering algorithm, a texture-compression algorithm, and/or a graphics-compression algorithm for eyewear device 100.

As a specific example, output 112 may approximate, simulate, and/or replace a traditional advanced rendering algorithm, such as a traditional bidirectional reflectance distribution function (BRDF) algorithm, for shading graphical imagery 116 in a graphics pipeline of hardware accelerator 120. In this example, output 112 may facilitate, support, and/or provide a neural BRDF algorithm without the power, compute, and/or time demands of its traditional counterpart. For example, hardware accelerator 120 may map a BRDF algorithm to a neural encoder/decoder architecture. By doing so, hardware accelerator 120 may effectively trade, swap, and/or replace certain compute operations involved in such a BRDF algorithm with a couple memory lookup operations. Additionally or alternatively, hardware accelerator 120 may perform and/or execute the memory lookup operations corresponding to the traded, swapped, and/or replaced compute operations.

In some examples, graphical imagery 116 may include and/or represent any type or form of visual and/or virtual content or media. Examples of graphical imagery 116 include, without limitation, computer-generated content, virtual objects, photographic images, videos, stills, combinations or variations of one or more of the same, and/or any other suitable graphical imagery.

In some examples, circuitry 106 and/or hardware accelerator 120 may store and/or maintain data representative of another instance of graphical imagery 116 in one or more of arrays 110 to facilitate the one or more lookup operations at a subsequent moment in time. Additionally or alternatively, circuitry 106 and/or hardware accelerator 120 may store and/or maintain, in one or more of arrays 110, data representative of additional graphical imagery that is similar to graphical imagery 116 to facilitate the one or more lookup operations at a subsequent moment in time. In one example, circuitry 106 and/or hardware accelerator 120 may effectively reuse such data to expedite the processing and/or rendering of graphical imagery 116 without performing redundant computations.

In some examples, circuitry 106 may include and/or represent one or more electrical and/or electronic circuits capable of processing, applying, modifying, transforming, displaying, transmitting, receiving, and/or executing data for eyewear device 100. In one example, circuitry 106 may process, modify, treat, filter, and/or render graphical imagery 116 using a differential indirection primitive determined and/or obtained via arrays 110. Additionally or alternatively, circuitry 106 may implement, apply, and/or modify certain virtual content and/or visual features presented to the user wearing eyewear frame 102. In certain implementations, circuitry 106 may provide such virtual content and/or visual features for presentation on display 104 to be sensed, consumed, and/or experienced by the user.

In some examples, circuitry 106 may launch, perform, and/or execute certain executable files, code snippets, and/or computer-readable instructions to facilitate and/or support approximating neural compute for graphics generation via hardware accelerators. Although illustrated as a single unit in FIG. 1, circuitry 106 may include and/or represent a collection of multiple processing units and/or electrical or electronic components that work and/or operate in conjunction with one another.

Examples of circuitry 106 include, without limitation, GPUs, hardware accelerators, processing devices, microprocessors, microcontrollers, field-programmable gate arrays (FPGAs), systems on chips (SoCs), parallel accelerated processors, tensor cores, integrated circuits, chiplets, optical modules, receivers, transmitters, transceivers, optical modules, memory devices, transistors, antennas, resistors, capacitors, diodes, inductors, switches, registers, flipflops, digital logic, connections, traces, buses, semiconductor (e.g., silicon) devices and/or structures, storage devices, audio controllers, portions of one or more of the same, variations or combinations of one or more of the same, and/or any other suitable circuitry. In certain implementations, circuitry 106 may execute and/or implement software and/or firmware that performs one or more of the steps and/or features described herein for approximating neural compute for graphics generation via hardware accelerators.

In some examples, hardware accelerator 120 may include and/or represent some or all of a GPU implemented on eyewear device 100. In one example, hardware accelerator 120 may include and/or represent some or all of an ASIC or SoC. Additionally or alternatively, hardware accelerator 120 may implement and/or provide some or all of a graphics rendering pipeline for eyewear device 100.

In some examples, display 104 may include and/or represent any type or form of device capable of presenting and/or display virtual content for viewing by the user. Examples of display 104 include, without limitation, a scanning display, a raster display, a retinal scan display, a virtual retinal display, a retinal projector, a display screen or panel, a liquid crystal display (LCD), a light-emitting diode (LED) display, an organic LED (OLED) display, a microLED display, a plasma display, a projector, a cathode ray tube, an optical mixer, combinations or variations of one or more of the same, and/or any other suitable type of display. In one example, display 104 may present videos, photos, and/or computer-generated imagery (CGI) to users. Additionally or alternatively, display 104 may include and/or incorporate see-through lenses that enable the user to see the user's surroundings in addition to such computer-generated content.

In some examples, eyewear frame 102 may include and/or represent any type or form of structure and/or assembly capable of securing, mounting, and/or housing display 104 and/or circuitry 106. In one example, eyewear frame 102 may be sized, dimensioned, and/or shaped in any suitable way to facilitate securing and/or mounting an artificial-reality device to the user's head or face. Eyewear frame 102 may include and/or contain a variety of different materials. Examples of such materials include, without limitation, plastics, acrylics, polyesters, metals (e.g., aluminum, magnesium, etc.), nylons, conductive materials, rubbers, neoprene, carbon fibers, composites, combinations or variations of one or more of the same, and/or any other suitable materials.

In some examples, eyewear device 100 may include and/or represent an HMD. In one example, the term “head-mounted display” and/or the abbreviation “HMD” may refer to any type or form of display device or system that is worn on or about a user's face and displays virtual content, such as computer-generated objects and/or AR content, to the user. HMDs may present and/or display content in any suitable way, including via a display screen. In certain implementations, HMDs may provide diverse and distinctive user experiences. Some HMDs may provide virtual reality experiences (i.e., they may display computer-generated or pre-recorded content), while other HMDs may provide real-world experiences (i.e., they may display live imagery from the physical world). HMDs may also provide any mixture of live and virtual content. For example, virtual content may be projected onto the physical world (e.g., via optical or video see-through lenses), which may result in AR and/or mixed reality experiences.

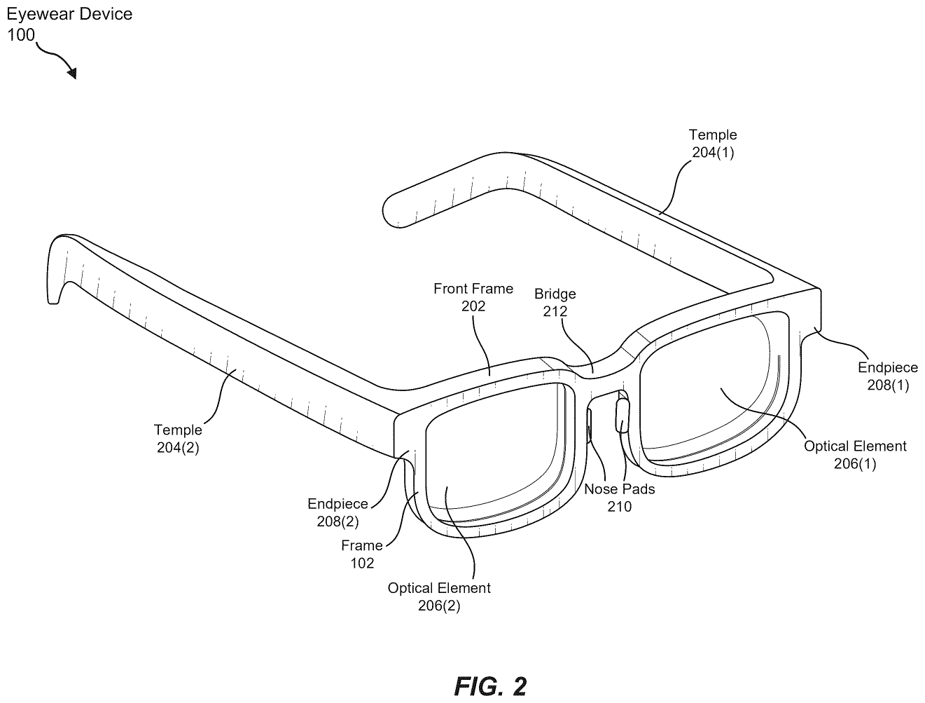

FIG. 2 illustrates an exemplary implementation of eyewear device 100 for approximating neural compute for graphics generation via hardware accelerators. In some examples, eyewear device 100 in FIG. 2 may include and/or represent certain devices, components, and/or features that perform and/or provide functionalities that are similar and/or identical to those described above in connection with FIG. 1. As illustrated in FIG. 2, eyewear device 100 may include and/or represent frame 102 dimensioned to be worn by a user. In one example, frame 102 may include and/or represent a front frame 202, temples 204(1) and 204(2), optical elements 206(1) and 206(2), endpieces 208(1) and 208(2), nose pads 210, and/or a bridge 212. Additionally or alternatively, frame 102 may include, implement, and/or incorporate display 104 and/or circuitry 106—some of which are not necessarily illustrated, visible, and/or labelled in FIG. 2.

In some examples, optical elements 206(1) and 206(2) may be inserted and/or installed in front frame 202. In other words, optical elements 206(1) and 206(2) may be coupled to, incorporated in, and/or held by frame 102. In one example, optical elements 206(1) and 206(2) may be configured and/or arranged to provide one or more virtual visual features for presentation to the user wearing eyewear device 100. These virtual visual features may be driven, influenced, and/or controlled by one or more wireless technologies supported by eyewear device 100.

In some examples, optical elements 206(1) and 206(2) may each include and/or represent optical stacks, lenses, and/or films. In one example, optical elements 206(1) and 206(2) may each include and/or represent various layers that facilitate and/or support the presentation of virtual features and/or elements that overlay real-world features and/or elements. Additionally or alternatively, optical elements 206(1) and 206(2) may each include and/or represent one or more screens, lenses, and/or fully or partially see-through components. Examples of optical elements 206(1) and 206(2) include, without limitation, electrochromic layers, dimming stacks, transparent conductive layers (such as indium tin oxide films), metal meshes, antennas, transparent resin layers, lenses, films, combinations or variations of one or more of the same, and/or any other suitable optical elements.

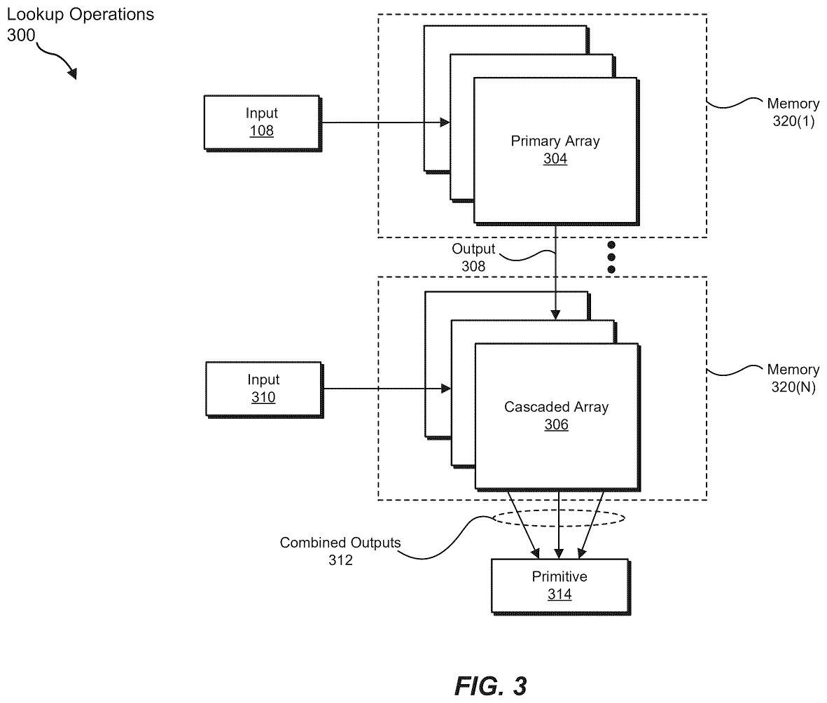

FIG. 3 illustrates an exemplary sequence of lookup operations 300 that facilitate and/or support approximating neural compute for graphics generation via hardware accelerators. In some examples, lookup operations 300 may include, involve, and/or represent certain devices, components, and/or features that perform and/or provide functionalities that are similar and/or identical to those described above in connection with either FIG. 1 or FIG. 2. As illustrated in FIG. 3, lookup operations 300 may involve a primary array 304 and/or a cascaded array 306 stored in memories 320(1)-(N) of eyewear device 100. In one example, circuitry 106 and/or hardware accelerator 120 may perform lookup operations 300 on primary array 304 and/or cascaded array 306 to approximate neural compute for graphics generation.

In some examples, primary array 304 and cascaded array 306 may be stored and/or implemented in the same memory device. In other examples, primary array 304 may stored and/or implemented in memory 320(1), and cascaded array 306 may be stored and/or implemented in memory 320(N). As a specific example, cascaded array 306 may include and/or represent a 16-by-16 array stored and/or implemented in cache memory. In certain implementations, memory 320(1) may include and/or represent L1 cache and/or L2 cache. Additionally or alternatively, memory 320(N) may include and/or represent L0 cache and/or L1 cache.

In some examples, hardware accelerator 120 may include, represent, and/or implement a neural encoder/decoder architecture. In one example, such an architecture may include, represent, and/or involve primary array 304 and/or memory 320(1) as the encoder and cascaded array 306 and/or memory 320(N) as the decoder. In this example, hardware accelerator 120 may perform lookup operations 300 on primary array 304 and/or cascaded array 306. For example, hardware accelerator 120 may perform a first lookup operation on primary array 304 to find a pointer that indicates and/or identifies a location in cascaded array 306 at which the data used to form a primitive 314 is stored. In this example, primitive 314 may constitute and/or represent a neural graphics primitive that effectively replaces the compute traditionally needed to process and/or render graphical imagery 116.

In some examples, memories 320(1)-(N) may include and/or represent any type or form of volatile or non-volatile storage device or medium capable of storing data and/or computer-readable instructions. In one example, memories 320(1)-(N) may store, load, and/or maintain certain modules, data, and/or computer-readable instructions accessible to circuitry 106 and/or hardware accelerator 120. Examples of memories 320(1)-(N) include, without limitation, cache (e.g., L0, L1, L2, and/or L3 caches), random access memory (RAM), read only memory (ROM), flash memory, hard disk drives (HDDs), solid-state drives (SSDs), optical disk drives, portions of one or more of the same, variations or combinations of one or more of the same, and/or any other suitable memory devices.

In some examples, memories 320(1)-(N) may be incorporated in and/or implemented on hardware accelerator 120 and/or circuitry 106. In other examples, memories 320(1)-(N) may be incorporated in eyewear device 100 and/or may be accessible to hardware accelerator 120 and/or circuitry 106.

In some examples, hardware accelerator 120 may identify and/or obtain input 108 that indicates one or more features of graphical imagery 116. In one example, hardware accelerator 120 may examine and/or analyze graphical imagery 116 and/or its metadata to extract and/or determine input 108. Additionally or alternatively, hardware accelerator 120 may receive and/or retrieve input 108 from another component and/or device included in circuitry 106.

In some examples, hardware accelerator 120 may perform a first lookup operation on primary array 304 with input 108. In one example, hardware accelerator 120 may identify and/or obtain an output 308 as a result of the first lookup operation. In this example, output 308 may include and/or represent a pointer that identifies the location that contains the data used to form primitive 314 in cascaded array 306. For example, the pointer may identify and/or point to the memory location at which primitive 314 and/or its constituent components are stored in memory 320(N).

In some examples, hardware accelerator 120 may apply output 308 as an input for a subsequent lookup operation performed on cascaded array 306. In one example, hardware accelerator 120 may identify and/or obtain combined outputs 312 as a result of the subsequent lookup operation. In other words, hardware accelerator 120 may combine a set of outputs from cascaded array 306 to form primitive 314. Hardware accelerator 120 may combine these outputs using one or more multiply, add, and/or logic operations. In this example, hardware accelerator 120 may then use and/or rely on primitive 314 to approximate the computation for rendering graphical imagery 116 according to input 108, the orientation of eyewear device 100, the environment occupied by the user, etc. By doing so, hardware accelerator 120 may generate, produce, and/or provide rendering 114 by applying primitive 314 to the instance of graphical imagery 116.

In some examples, hardware accelerator 120 may also apply an input 310 (e.g., in addition to output 308) to the subsequent lookup operation performed on cascaded array 306. In one example, input 310 may indicate, represent, and/or correspond to the orientation of eyewear device 100, the direction viewed contemporaneously by the user wearing eyewear device 100, and/or the environment occupied by the user. Accordingly, lookup operations 300 may render, form, and/or lead to primitive 314 based at least in part on input 108 and/or input 310.

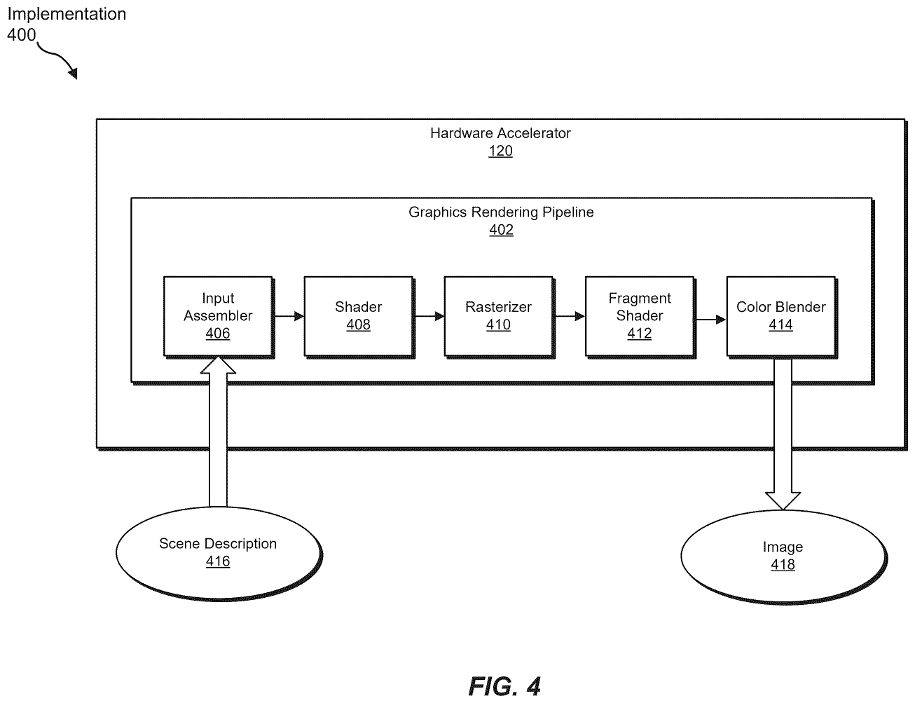

FIG. 4 illustrates an exemplary implementation 400 of hardware accelerator 120 capable of approximating neural compute for graphics generation. In some examples, implementation 400 may include, involve, and/or represent certain devices, components, and/or features that perform and/or provide functionalities that are similar and/or identical to those described above in connection with any of FIGS. 1-3. As illustrated in FIG. 4, implementation 400 may involve hardware accelerator 120 configured to execute and/or provide a graphics rendering pipeline 402 that processes, modifies, generates, and/or renders graphical imagery for presentation on display 104. In one example, graphics rendering pipeline 402 may include and/or represent an input assembler 406, a shader 408, a rasterizer 410, a fragment shader 412, and/or a color blender 414.

In some examples, circuitry 106 and/or hardware accelerator 120 may deliver, provide, and/or transmit a scene description 416 of graphical imagery 116 to graphics rendering pipeline 402 and/or input assembler 406. In one example, scene description 416 may include and/or represent data that indicates and/or represents a scene depicted or portrayed in graphical imagery 116 and/or an initial version of graphical imagery 116. In this example, input assembler 406 may convert, translate, and/or distill scene description 416 into a data format that is acceptable and/or suitable as an input for shader 408. In certain implementations, shader 408 may include and/or represent a vertex shader, a geometry shader, a two-dimensional (2D) shader, a three-dimensional (3D) shader, and/or a tessellation shader that performs certain types of shading on graphical imagery 116.

In some examples, rasterizer 410 may rasterize graphical imagery 116 and/or map the scene geometry of graphical imagery 116 to pixels of display 104 and/or the corresponding format. In one example, fragment shader 412 may include and/or represent a pixel shader that determines and/or applies color and/or other attributes for each fragment and/or pixel of graphical imagery 116. In certain implementations, fragment shader 412 may constitute and/or represent the portion or stage of graphics rendering pipeline 402 that performs lookup operations 300 and/or uses primitive 314 to approximate the neural compute for shading fragments and/or pixels of graphical imagery 116. In such implementations, fragment shader 412 may simulate the scattering of light as applied to graphical imagery 116 for viewing by the user.

In some examples, color blender 414 may blend the colors of the fragments and/or pixels included graphical imagery 116. In one example, after having traversed graphics rendering pipeline 402 and/or undergone the processing performed by the various stages of graphics rendering pipeline 402, the initial version of graphical imagery 116 may be transformed into and/or output as an image 418 for presentation by display 104. In this example, image 418 may constitute and/or represent a frame of graphical imagery 116 rendered for viewing by the user based at least in part on input 108 and/or input 310.

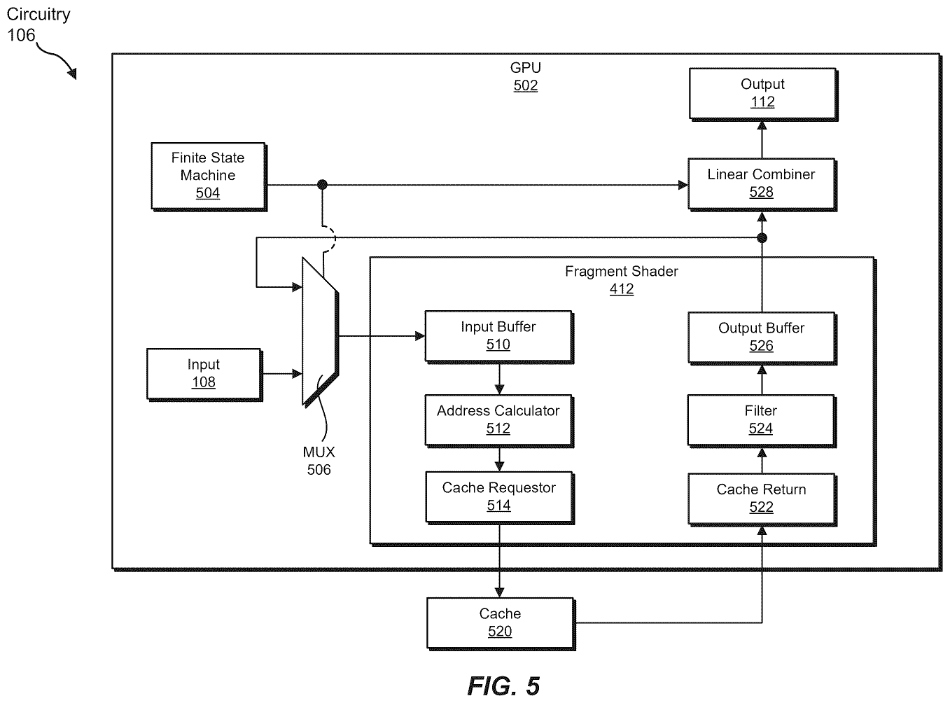

FIG. 5 illustrates an exemplary implementation of at least a portion of circuitry 106 capable of approximating neural compute for graphics generation. In some examples, circuitry 106 may include, involve, and/or represent certain devices, components, and/or features that perform and/or provide functionalities that are similar and/or identical to those described above in connection with any of FIGS. 1-4. As illustrated in FIG. 5, circuitry 106 may include and/or represent a GPU 502 that renders and/or provides output 112 based at least in part on input 108. In one example, GPU 502 may constitute and/or represent a specific implementation of hardware accelerator 120.

In some examples, GPU 502 may include and/or represent a multiplexer (MUX) 506, fragment shader 412, a cache 520, and/or a linear combiner 528. Although illustrated as being external to and/or separate from GPU 502 in FIG. 5, cache 520 and/or linear combiner 528 may alternatively represent part of and/or be included in GPU 502. In one example, fragment shader 412 may be communicatively coupled between MUX 506 and linear combiner 528. In certain implementations, fragment shader 412 may include and/or represent an input buffer 510, an address calculator 512, a cache requestor 514, a cache return 522, a filter 524, and/or an output buffer 526.

In some examples, MUX 506 may multiplex and/or select either input 108 and/or the output of fragment shader 412 to be forwarded to input buffer 510 depending on a finite state machine 504. For example, finite state machine 504 may cause MUX 506 to forward and/or pass either input 108 or the output of fragment shader 412 to input buffer 510. In this example, the selection between input 108 and the output of fragment shader 412 may be made by MUX 506 according to the current condition of finite state machine 504.

In some examples, fragment shader 412 may rely on input buffer 510 and/or address calculator 512 to determine the address at which the corresponding primitive data is stored in cache 520. In one example, cache 520 may deliver, provide, and/or transmit the corresponding primitive data stored in that address to cache return 522 of fragment shader 412. In this example, fragment shader 412 may rely on cache return 522 and/or filter 524 to filter, convert, and/or translate the primitive data into a data format that is acceptable and/or suitable for linear combiner 528.

In certain implementations, output buffer 526 may output and/or provide the primitive data to linear combiner 528 for combining and/or distilling the primitive data into output 112. In such implementations, linear combiner 528 may combine and/or distill the primitive data into a function geometric primitive that GPU 502 applies to graphical imagery 116 to produce and/or generate at least one portion or characteristic of rendering 114.

In some examples, the various apparatuses, devices, and systems described in connection with FIGS. 1-5 may include and/or represent one or more additional circuits, components, and/or features that are not necessarily illustrated and/or labeled in FIGS. 1-5. For example, the apparatuses, devices, and systems illustrated in FIGS. 1-5 may also include and/or represent additional analog and/or digital circuitry, onboard logic, transistors, radio-frequency (RF) transmitters, RF receivers, RF transceivers, antennas, resistors, capacitors, diodes, inductors, switches, registers, flipflops, digital logic, connections, traces, buses, semiconductor (e.g., silicon) devices and/or structures, processing devices, storage devices, circuit boards, sensors, packages, substrates, housings, combinations or variations of one or more of the same, and/or any other suitable components. In certain implementations, one or more of these additional circuits, components, and/or features may be inserted and/or applied between any of the existing circuits, components, and/or features illustrated in FIGS. 1-5 consistent with the aims and/or objectives described herein. Accordingly, the couplings and/or connections described with reference to FIGS. 1-5 may be direct connections with no intermediate components, devices, and/or nodes or indirect connections with one or more intermediate components, devices, and/or nodes.

In some examples, the phrase “to couple” and/or the term “coupling”, as used herein, may refer to a direct connection and/or an indirect connection. For example, a direct coupling between two components may constitute and/or represent a coupling in which those two components are directly connected to each other by a single node that provides continuity from one of those two components to the other. In other words, the direct coupling may exclude and/or omit any additional components between those two components.

Additionally or alternatively, an indirect coupling between two components may constitute and/or represent a coupling in which those two components are indirectly connected to each other by multiple nodes that fail to provide continuity from one of those two components to the other. In other words, the indirect coupling may include and/or incorporate at least one additional component between those two components. In some examples, one or more components and/or features illustrated in FIGS. 1-5 may be excluded and/or omitted from the various apparatuses, devices, and/or systems described in connection with FIGS. 1-5.

FIG. 6 is a flow diagram of an exemplary method 600 for approximating neural compute for graphics generation via hardware accelerators. In one example, the steps shown in FIG. 6 may be performed and/or carried out by an AR/VR equipment manufacturer and/or subcontractor. Additionally or alternatively, the steps shown in FIG. 6 may incorporate and/or involve certain sub-steps and/or variations consistent with the descriptions provided above in connection with FIGS. 1-5.

As illustrated in FIG. 6, method 600 may include the step of coupling circuitry and a display to an eyewear frame dimensioned to be worn by a user (610). Step 610 may be performed in a variety of ways, including any of those described above in connection with FIGS. 1-5. For example, an AR/VR equipment manufacturer and/or subcontractor may couple circuitry and a display to an eyewear frame dimensioned to be worn by a user.

Method 600 may also include the step of configuring a hardware accelerator included in the circuitry to identify an input that indicates one or more features of an instance of graphical imagery (620). Step 620 may be performed in a variety of ways, including any of those described above in connection with FIGS. 1-5. For example, the AR/VR equipment manufacturer and/or subcontractor may configure a hardware accelerator included in the circuitry to identify an input that indicates one or more features of an instance of graphical imagery.

Method 600 may further include the step of configuring the hardware accelerator to perform, based at least in part on the input, one or more lookup operations via one or more arrays to obtain an output used to approximate computation of a rendering of the instance of graphical imagery (630). Step 630 may be performed in a variety of ways, including any of those described above in connection with FIGS. 1-5. For example, the AR/VR equipment manufacturer and/or subcontractor may configure the hardware accelerator to perform, based at least in part on the input, one or more lookup operations via one or more arrays to obtain an output used to approximate computation of a rendering of the instance of graphical imagery.

Method 600 may further include the step of configuring the display to present the rendering of the instance of graphical imagery to the user (640). Step 640 may be performed in a variety of ways, including any of those described above in connection with FIGS. 1-5. For example, the AR/VR equipment manufacturer and/or subcontractor may configure the display to present the rendering of the instance of graphical imagery to the user.

### Example Embodiments

Example 1: An eyewear device comprising (1) an eyewear frame dimensioned to be worn by a user, (2) circuitry coupled to the eyewear frame, the circuitry comprising a hardware accelerator configured to (A) identify an input that indicates one or more features of an instance of graphical imagery and (B) perform, based at least in part on the input, one or more lookup operations via one or more arrays to obtain an output used to approximate computation of a rendering of the instance of graphical imagery, and (3) a display coupled to the eyewear frame and configured to present the rendering of the instance of graphical imagery to the user.

Example 2: The eyewear device of Example 1, wherein the hardware accelerator is further configured to (1) perform a sequence of lookup operations via a primary array and a cascaded array and (2) combine a set of outputs from the cascaded array to form a primitive used to approximate computation for the rendering.

Example 3: The eyewear device of either Example 1 or Example 2, wherein the hardware accelerator is further configured to (1) obtain a first output from the primary array by performing a first lookup operation on the primary array, (2) apply the first output as an additional input for a subsequent lookup operation on the cascaded array, and (3) obtain the set of outputs from the cascaded array by performing the subsequent lookup operation with the additional input on the cascaded array.

Example 4: The eyewear device of any of Examples 1-3, further comprising a cache memory configured to store the cascaded array, wherein the hardware accelerator is further configured to perform a first lookup operation on the primary array to obtain a pointer that identifies a location at which the primitive is stored in the cache memory.

Example 5: The eyewear device of any of Examples 1-4, wherein the hardware accelerator is further configured to generate the rendering by applying the primitive to the instance of graphical imagery.

Example 6: The eyewear device of any of Examples 1-5, wherein the hardware accelerator is further configured to shade the rendering based at least in part on the primitive.

Example 7: The eyewear device of any of Examples 1-6, wherein the hardware accelerator comprises at least a portion of a graphics processing unit (GPU) and the cascaded array comprises a 16-by-16 array of memory location in the cache memory.

Example 8: The eyewear device of any of Examples 1-7, wherein the output used to approximate computation of the rendering comprises a function that approximates at least one of a graphical rendering algorithm, a texture-compression algorithm, or a graphics-compression algorithm.

Example 9: The eyewear device of any of Examples 1-8, wherein the hardware accelerator is further configured to (1) store data representative of another instance of the graphical imagery in the one or more arrays to facilitate the one or more lookup operations at a subsequent moment in time or (2) store data representative of additional graphical imagery that is comparable to the graphical imagery in the one or more arrays to facilitate the one or more lookup operations at a subsequent moment in time.

Example 10: The eyewear device of any of Examples 1-9, wherein the one or more features indicated by the input comprise direction of light applied to or represented in the instance of graphical imagery, surface roughness of at least a portion of the instance of graphical imagery, metallicity of at least a portion of the instance of graphical imagery, anisotropy of at least a portion of the instance of graphical imagery, specularity of at least a portion of the instance of graphical imagery, and/or sheen of at least a portion of the instance of graphical imagery.

Example 11: An artificial-reality system comprising (1) an eyewear frame dimensioned to be worn by a user, (2) a graphics processing unit (GPU) configured to (A) identify an input that indicates one or more features of an instance of graphical imagery and (B) perform, based at least in part on the input, one or more lookup operations via one or more arrays to obtain an output used to approximate computation of a rendering of the instance of graphical imagery, and (3) a display coupled to the eyewear frame and configured to present the rendering of the instance of graphical imagery to the user.

Example 12: The artificial-reality system of Example 11, wherein the GPU is further configured to (1) perform a sequence of lookup operations via a primary array and a cascaded array and (2) combine a set of outputs from the cascaded array to form a primitive used to approximate computation for the rendering.

Example 13: The artificial-reality system of either Example 11 or Example 12, wherein the GPU is further configured to (1) obtain a first output from the primary array by performing a first lookup operation on the primary array, (2) apply the first output as an additional input for a subsequent lookup operation on the cascaded array, and (3) obtain the set of outputs from the cascaded array by performing the subsequent lookup operation with the additional input on the cascaded array.

Example 14: The artificial-reality system of any of Examples 11-13, further comprising a cache memory configured to store the cascaded array, wherein the GPU is further configured to perform a first lookup operation on the primary array to obtain a pointer that identifies a location at which the primitive is stored in the cache memory.

Example 15: The artificial-reality system of any of Examples 11-14, wherein the GPU is further configured to generate the rendering by applying the primitive to the instance of graphical imagery.

Example 16: The artificial-reality system of any of Example 11-15, wherein the GPU is further configured to shade the rendering based at least in part on the primitive.

Example 17: The artificial-reality system of any of Examples 11-16, wherein the cascaded array comprises a 16-by-16 array of memory location in the cache memory.

Example 18: The artificial-reality system of any of Examples 11-17, wherein the output used to approximate computation of the rendering comprises a function that approximates a graphical rendering algorithm, a texture-compression algorithm, and/or a graphics-compression algorithm.

Example 19: The artificial-reality system of any of Examples 11-18, wherein the GPU is further configured to (1) store data representative of another instance of the graphical imagery in the one or more arrays to facilitate the one or more lookup operations at a subsequent moment in time or (2) store data representative of additional graphical imagery that is comparable to the graphical imagery in the one or more arrays to facilitate the one or more lookup operations at a subsequent moment in time.

Example 20: A method comprising (1) coupling circuitry and a display to an eyewear frame dimensioned to be worn by a user, (2) configuring a hardware accelerator included in the circuitry to (A) identify an input that indicates one or more features of an instance of graphical imagery and (B) perform, based at least in part on the input, one or more lookup operations via one or more arrays to obtain an output used to approximate computation of a rendering of the instance of graphical imagery, and (3) configuring the display to present the rendering of the instance of graphical imagery to the user.

Embodiments of the present disclosure may include or be implemented in conjunction with various types of artificial-reality systems. Artificial reality is a form of reality that has been adjusted in some manner before presentation to a user, which may include, for example, a VR, an AR, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a 3D effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 700 in FIG. 7) or that visually immerses a user in an artificial reality (such as, e.g., virtual-reality system 800 in FIG. 8). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 7, augmented-reality system 700 may include an eyewear device 702 with a frame 710 configured to hold a left display device 715(A) and a right display device 715(B) in front of a user's eyes. Display devices 715(A) and 715(B) may act together or independently to present an image or series of images to a user. While augmented-reality system 700 includes two displays, embodiments of this disclosure may be implemented in augmented-reality systems with a single NED or more than two NEDs.

In some embodiments, augmented-reality system 700 may include one or more sensors, such as sensor 740. Sensor 740 may generate measurement signals in response to motion of augmented-reality system 700 and may be located on substantially any portion of frame 710. Sensor 740 may represent one or more of a variety of different sensing mechanisms, such as a position sensor, an inertial measurement unit (IMU), a depth camera assembly, a structured light emitter and/or detector, or any combination thereof. In some embodiments, augmented-reality system 700 may or may not include sensor 740 or may include more than one sensor. In embodiments in which sensor 740 includes an IMU, the IMU may generate calibration data based on measurement signals from sensor 740. Examples of sensor 740 may include, without limitation, accelerometers, gyroscopes, magnetometers, other suitable types of sensors that detect motion, sensors used for error correction of the IMU, or some combination thereof.

In some examples, augmented-reality system 700 may also include a microphone array with a plurality of acoustic transducers 720(A)-720(J), referred to collectively as acoustic transducers 720. Acoustic transducers 720 may represent transducers that detect air pressure variations induced by sound waves. Each acoustic transducer 720 may be configured to detect sound and convert the detected sound into an electronic format (e.g., an analog or digital format). The microphone array in FIG. 7 may include, for example, ten acoustic transducers: 720(A) and 720(B), which may be designed to be placed inside a corresponding ear of the user, acoustic transducers 720(C), 720(D), 720(E), 720(F), 720(G), and 720(H), which may be positioned at various locations on frame 710, and/or acoustic transducers 720(I) and 720(J), which may be positioned on a corresponding neckband 705.

In some embodiments, one or more of acoustic transducers 720(A)-(J) may be used as output transducers (e.g., speakers). For example, acoustic transducers 720(A) and/or 720(B) may be earbuds or any other suitable type of headphone or speaker.

The configuration of acoustic transducers 720 of the microphone array may vary. While augmented-reality system 700 is shown in FIG. 7 as having ten acoustic transducers 720, the number of acoustic transducers 720 may be greater or less than ten. In some embodiments, using higher numbers of acoustic transducers 720 may increase the amount of audio information collected and/or the sensitivity and accuracy of the audio information. In contrast, using a lower number of acoustic transducers 720 may decrease the computing power required by an associated controller 750 to process the collected audio information. In addition, the position of each acoustic transducer 720 of the microphone array may vary. For example, the position of an acoustic transducer 720 may include a defined position on the user, a defined coordinate on frame 710, an orientation associated with each acoustic transducer 720, or some combination thereof.

Acoustic transducers 720(A) and 720(B) may be positioned on different parts of the user's ear, such as behind the pinna, behind the tragus, and/or within the auricle or fossa. Or, there may be additional acoustic transducers 720 on or surrounding the ear in addition to acoustic transducers 720 inside the ear canal. Having an acoustic transducer 720 positioned next to an ear canal of a user may enable the microphone array to collect information on how sounds arrive at the ear canal. By positioning at least two of acoustic transducers 720 on either side of a user's head (e.g., as binaural microphones), AR system 700 may simulate binaural hearing and capture a 3D stereo sound field around about a user's head. In some embodiments, acoustic transducers 720(A) and 720(B) may be connected to augmented-reality system 700 via a wired connection 730, and in other embodiments acoustic transducers 720(A) and 720(B) may be connected to augmented-reality system 700 via a wireless connection (e.g., a BLUETOOTH connection). In still other embodiments, acoustic transducers 720(A) and 720(B) may not be used at all in conjunction with augmented-reality system 700.

Acoustic transducers 720 on frame 710 may be positioned in a variety of different ways, including along the length of the temples, across the bridge, above or below display devices 715(A) and 715(B), or some combination thereof. Acoustic transducers 720 may also be oriented such that the microphone array is able to detect sounds in a wide range of directions surrounding the user wearing the augmented-reality system 700. In some embodiments, an optimization process may be performed during manufacturing of augmented-reality system 700 to determine relative positioning of each acoustic transducer 720 in the microphone array.

In some examples, augmented-reality system 700 may include or be connected to an external device (e.g., a paired device), such as neckband 705. Neckband 705 generally represents any type or form of paired device. Thus, the following discussion of neckband 705 may also apply to various other paired devices, such as charging cases, smart watches, smart phones, wrist bands, other wearable devices, hand-held controllers, tablet computers, laptop computers, other external compute devices, etc.

As shown, neckband 705 may be coupled to eyewear device 702 via one or more connectors. The connectors may be wired or wireless and may include electrical and/or non-electrical (e.g., structural) components. In some cases, eyewear device 702 and neckband 705 may operate independently without any wired or wireless connection between them. While FIG. 7 illustrates the components of eyewear device 702 and neckband 705 in example locations on eyewear device 702 and neckband 705, the components may be located elsewhere and/or distributed differently on eyewear device 702 and/or neckband 705. In some embodiments, the components of eyewear device 702 and neckband 705 may be located on one or more additional peripheral devices paired with eyewear device 702, neckband 705, or some combination thereof.

Pairing external devices, such as neckband 705, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 700 may be provided by a paired device or shared between a paired device and an eyewear device, thus reducing the weight, heat profile, and form factor of the eyewear device overall while still retaining desired functionality. For example, neckband 705 may allow components that would otherwise be included on an eyewear device to be included in neckband 705 since users may tolerate a heavier weight load on their shoulders than they would tolerate on their heads. Neckband 705 may also have a larger surface area over which to diffuse and disperse heat to the ambient environment. Thus, neckband 705 may allow for greater battery and computation capacity than might otherwise have been possible on a stand-alone eyewear device. Since weight carried in neckband 705 may be less invasive to a user than weight carried in eyewear device 702, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 705 may be communicatively coupled with eyewear device 702 and/or to other devices. These other devices may provide certain functions (e.g., tracking, localizing, depth mapping, processing, storage, etc.) to augmented-reality system 700. In the embodiment of FIG. 7, neckband 705 may include two acoustic transducers (e.g., 720(I) and 720(J)) that are part of the microphone array (or potentially form their own microphone subarray). Neckband 705 may also include a controller 725 and a power source 735.

Acoustic transducers 720(1) and 720(J) of neckband 705 may be configured to detect sound and convert the detected sound into an electronic format (analog or digital). In the embodiment of FIG. 7, acoustic transducers 720(I) and 720(J) may be positioned on neckband 705, thereby increasing the distance between the neckband acoustic transducers 720(I) and 720(J) and other acoustic transducers 720 positioned on eyewear device 702. In some cases, increasing the distance between acoustic transducers 720 of the microphone array may improve the accuracy of beamforming performed via the microphone array. For example, if a sound is detected by acoustic transducers 720(C) and 720(D) and the distance between acoustic transducers 720(C) and 720(D) is greater than, e.g., the distance between acoustic transducers 720(D) and 720(E), the determined source location of the detected sound may be more accurate than if the sound had been detected by acoustic transducers 720(D) and 720(E).

Controller 725 of neckband 705 may process information generated by the sensors on neckband 705 and/or augmented-reality system 700. For example, controller 725 may process information from the microphone array that describes sounds detected by the microphone array. For each detected sound, controller 725 may perform a direction-of-arrival (DOA) estimation to estimate a direction from which the detected sound arrived at the microphone array. As the microphone array detects sounds, controller 725 may populate an audio data set with the information. In embodiments in which augmented-reality system 700 includes an inertial measurement unit, controller 725 may compute all inertial and spatial calculations from the IMU located on eyewear device 702. A connector may convey information between augmented-reality system 700 and neckband 705 and between augmented-reality system 700 and controller 725. The information may be in the form of optical data, electrical data, wireless data, or any other transmittable data form. Moving the processing of information generated by augmented reality system 700 to neckband 705 may reduce weight and heat in eyewear device 702, making it more comfortable to the user.

Power source 735 in neckband 705 may provide power to eyewear device 702 and/or to neckband 705. Power source 735 may include, without limitation, lithium-ion batteries, lithium-polymer batteries, primary lithium batteries, alkaline batteries, or any other form of power storage. In some cases, power source 735 may be a wired power source. Including power source 735 on neckband 705 instead of on eyewear device 702 may help better distribute the weight and heat generated by power source 735.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 800 in FIG. 8, that mostly or completely covers a user's field of view. Virtual-reality system 800 may include a front rigid body 802 and a band 804 shaped to fit around a user's head. Virtual-reality system 800 may also include output audio transducers 806(A) and 806(B). Furthermore, while not shown in FIG. 8, front rigid body 802 may include one or more electronic elements, including one or more electronic displays, one or more inertial measurement units (IMUs), one or more tracking emitters or detectors, and/or any other suitable device or system for creating an artificial-reality experience.

Artificial-reality systems may include a variety of types of visual feedback mechanisms. For example, display devices in augmented-reality system 700 and/or virtual-reality system 800 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 700 and/or virtual-reality system 800 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 700 and/or virtual-reality system 800 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference may be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

What is claimed is:

1. An eyewear device comprising:
an eyewear frame dimensioned to be worn by a user;
circuitry coupled to the eyewear frame, the circuitry comprising a hardware accelerator configured to:
identify an input that indicates one or more features of an instance of graphical imagery; and
perform, based at least in part on the input, one or more lookup operations via one or more arrays to obtain an output used to approximate computation of a rendering of the instance of graphical imagery; and
a display coupled to the eyewear frame and configured to present the rendering of the instance of graphical imagery to the user.

2. The eyewear device of claim 1, wherein the hardware accelerator is further configured to:
perform a sequence of lookup operations via a primary array and a cascaded array; and
combine a set of outputs from the cascaded array to form a primitive used to approximate computation for the rendering.

3. The eyewear device of claim 2, wherein the hardware accelerator is further configured to:
obtain a first output from the primary array by performing a first lookup operation on the primary array;
apply the first output as an additional input for a subsequent lookup operation on the cascaded array; and
obtain the set of outputs from the cascaded array by performing the subsequent lookup operation with the additional input on the cascaded array.

4. The eyewear device of claim 2, further comprising a cache memory configured to store the cascaded array, wherein the hardware accelerator is further configured to perform a first lookup operation on the primary array to obtain a pointer that identifies a location at which the primitive is stored in the cache memory.

5. The eyewear device of claim 4, wherein the hardware accelerator is further configured to generate the rendering by applying the primitive to the instance of graphical imagery.

6. The eyewear device of claim 5, wherein the hardware accelerator is further configured to shade the rendering based at least in part on the primitive.

7. The eyewear device of claim 4, wherein:
the hardware accelerator comprises at least a portion of a graphics processing unit (GPU); and
the cascaded array comprises a 16-by-16 array of memory locations in the cache memory.

8. The eyewear device of claim 1, wherein the output used to approximate computation of the rendering comprises a function that approximates at least one of:
a graphics-rendering algorithm;
a texture-compression algorithm; or
a graphics-compression algorithm.

9. The eyewear device of claim 1, wherein the hardware accelerator is further configured to:
store data representative of another instance of the graphical imagery in the one or more arrays to facilitate the one or more lookup operations at a subsequent moment in time; or
store data representative of additional graphical imagery that is comparable to the graphical imagery in the one or more arrays to facilitate the one or more lookup operations at a subsequent moment in time.

10. The eyewear device of claim 1, wherein the one or more features indicated by the input comprise at least one of:
direction of light applied to or represented in the instance of graphical imagery;
surface roughness of at least a portion of the instance of graphical imagery;
metallicity of at least a portion of the instance of graphical imagery;
anisotropy of at least a portion of the instance of graphical imagery;
specularity of at least a portion of the instance of graphical imagery; or
sheen of at least a portion of the instance of graphical imagery.

11. An artificial-reality system comprising:
an eyewear frame dimensioned to be worn by a user;
a graphics processing unit (GPU) configured to:
identify an input that indicates one or more features of an instance of graphical imagery; and
perform, based at least in part on the input, one or more lookup operations via one or more arrays to obtain an output used to approximate computation of a rendering of the instance of graphical imagery; and
a display coupled to the eyewear frame and configured to present the rendering of the instance of graphical imagery to the user.

12. The artificial-reality system of claim 11, wherein the GPU is further configured to:
perform a sequence of lookup operations via a primary array and a cascaded array; and
combine a set of outputs from the cascaded array to form a primitive used to approximate computation for the rendering.

13. The artificial-reality system of claim 12, wherein the GPU is further configured to:
obtain a first output from the primary array by performing a first lookup operation on the primary array;
apply the first output as an additional input for a subsequent lookup operation on the cascaded array; and
obtain the set of outputs from the cascaded array by performing the subsequent lookup operation with the additional input on the cascaded array.

14. The artificial-reality system of claim 12, further comprising a cache memory configured to store the cascaded array, wherein the GPU is further configured to perform a first lookup operation on the primary array to obtain a pointer that identifies a location at which the primitive is stored in the cache memory.

15. The artificial-reality system of claim 14, wherein the GPU is further configured to generate the rendering by applying the primitive to the instance of graphical imagery.

16. The artificial-reality system of claim 15, wherein the GPU is further configured to shade the rendering based at least in part on the primitive.

17. The artificial-reality system of claim 14, wherein the cascaded array comprises a 16-by-16 array of memory location in the cache memory.

18. The artificial-reality system of claim 11, wherein the output used to approximate computation of the rendering comprises a function that approximates at least one of:
a graphics-rendering algorithm;
a texture-compression algorithm; or
a graphics-compression algorithm.

19. The artificial-reality system of claim 11, wherein the GPU is further configured to:
store data representative of another instance of the graphical imagery in the one or more arrays to facilitate the one or more lookup operations at a subsequent moment in time; or
store data representative of additional graphical imagery that is comparable to the graphical imagery in the one or more arrays to facilitate the one or more lookup operations at a subsequent moment in time.

20. A method comprising:
coupling circuitry and a display to an eyewear frame dimensioned to be worn by a user;
configuring a hardware accelerator included in the circuitry to:
identify an input that indicates one or more features of an instance of graphical imagery; and
perform, based at least in part on the input, one or more lookup operations via one or more arrays to obtain an output used to approximate computation of a rendering of the instance of graphical imagery; and
configuring the display to present the rendering of the instance of graphical imagery to the user.
